(19) United States
(12) Patent Application Publication
(10) Pub. No.: US 2014/0040173 A1
(43) Pub. Date: Feb. 6, 2014

(54) SYSTEM AND METHOD FOR DETECTION OF A CHARACTERISTIC IN SAMPLES OF A SAMPLE SET

(71) Applicant: VIDEO INFORM LTD., Petach Tikva (IL)

(72) Inventors: Yoram SAGHER, Hod Hasharon (IL); Ronen Saggir, Rishon Letzion (IL); Moshe Butman, Petah Tikva (IL); Lahav Yeffet, Rehovot (IL); Rani Amar, Givat Shmuel (IL)

(73) Assignee: VIDEO INFORM LTD., Petach Tikva (IL)

(21) Appl. No.: 13/958,058

(22) Filed: Aug. 2, 2013

Related U.S. Application Data
(60) Provisional application No. 61/678,947, filed on Aug. 2, 2012.
(60) Provisional application No. 61/706,158, filed on Sep. 27, 2012.

(51) Int. Cl. G06N 99/00

(52) U.S. Cl. CPC G06N 99/005
USPC 706/12

(57) ABSTRACT

A computer-implemented method for detecting a characteristic in a sample of a set of samples is described. The method may include receiving from a user an indication for each sample of said set of samples that the user determines to include the characteristic. The method may also include defining samples of said set of samples that were not indicated by the user to include the characteristic as not including the characteristic. The method may further include iteratively applying by a processing unit, a detection algorithm on a first subset of the set of samples, said detection algorithm using a set of detection criteria that includes one or a plurality of detection criteria, evaluating a detection performance of the detection algorithm and modifying the detection algorithm by making changes in the set of detection criteria to enhance detection performance of the learning algorithm. The method may still further include, upon reaching a desired level of detection performance for the modified detection algorithm, performing validation by testing the modified detection algorithm on a second subset of the set of samples.

### CROSS-REFERENCE TO RELATED APPLICATIONS

The present application claims priority from U.S. Provisional Patent Application No. 61/678,947, filed on Aug. 2, 2012, and from U.S. Provisional Patent Application No. 61/706,158, filed on Sep. 27, 2012, both of which are incorporated herein by reference in their entirety.

### FIELD OF THE INVENTION

Embodiments of the present invention relate to systems and methods for detecting a presence of a characteristic in a sample of set of sample and more particularly, to a user trained detection system and method.

### BACKGROUND OF THE INVENTION

Special purpose detecting systems are known, which are aimed at specific detection requirements. For example, smoke detectors, pressure detectors, burglary detectors, face detectors, motion detectors and industrial inspection detectors, etc. Some special purpose detecting systems, such as, for example, smoke detectors, pressure detectors and burglary detectors, are easy to implement, inexpensive and provide an adequate solution to the particular detection problem, while other detecting devices, such as face detectors, are more complicated, requiring one or more sensors (e.g. cameras) for sensing data and a processor for analyzing the sensed data.

The advances of recent years in sensor and processing technologies have led to the introduction of detecting devices capable of dealing with added complexity detection problems.

Object tracking, such as surveillance or traffic control and management, typically involves unattended detection of events by utilizing vision or other sensors and collecting large amounts of image data, which can then be used by an image processing system to detect an event and track the detected event without human supervision.

Existing detecting systems typically provide tools for quick image data acquisition and preliminary processing using image-processing software algorithms for enhancing processing speed so as to allow shortened response times.

Though there has been significant progress in event detectors, enhancement of their performance and uncomplicated adaptation to varying conditions are still highly desired.

### SUMMARY OF THE INVENTION

There is thus provided, in accordance with some embodiments of the present invention, a computer-implemented method for detecting a characteristic in a sample of a set of samples. The method may include receiving from a user an indication for each sample of said set of samples that the user determines to include the characteristic. The method may also include defining samples of said set of samples that were not indicated by the user to include the characteristic as not including the characteristic.

The method may further include iteratively, applying by a processing unit, a detection algorithm on a first subset of the set of samples, said detection algorithm using a set of detection criteria that includes one or a plurality of detection criteria, evaluating a detection performance of the detection algorithm and modifying the detection algorithm by making changes in the set of detection criteria to enhance detection performance of the learning algorithm.

The method may still further include, upon reaching a desired level of detection performance for the modified detection algorithm, performing validation by testing the modified detection algorithm on a second subset of the set of samples.

Furthermore, according to some embodiments, the method may further include presenting to the user, via a user interface, samples of the set of samples that were not indicated by the user as including the characteristic, for the user to verify whether the characteristic is or is not included in these samples.

In some embodiments of the present invention, the samples of the set of samples that were not indicated by the user as including the characteristic were found by the modified detection algorithm to include the characteristic with a certainty level of or above a predetermined value.

In some embodiments, the samples of the set of samples that were not indicated by the user as including the characteristic were found by the modified detection algorithm to include the characteristic within a predetermined range of certainty levels.

According to some embodiments of the present invention, the samples include images and wherein the characteristic includes an object to be detected in the images.

In some embodiments, the detection criteria are selected randomly.

According to embodiments of the present invention, a system for detecting a characteristic in a sample of a set of samples is provided. The system may include a processing unit configured to receive from a user an indication for each sample of said set of samples that the user determines to include the characteristic. The processing unit may also be configured to define samples of said set of samples that were not indicated by the user to include the characteristic as not including the characteristic. The processing unit may be also configured to iteratively, apply by a processing unit, a detection algorithm on a first subset of the set of samples, said detection algorithm using a set of detection criteria that includes one or a plurality of detection criteria, evaluate a detection performance of the detection algorithm and modify the detection algorithm by making changes in the set of detection criteria to enhance detection performance of the learning algorithm. The processing unit may still further be configured upon reaching a desired level of detection performance for the modified detection algorithm, to perform validation by testing the modified detection algorithm on a second subset of the set of samples.

In some embodiments, the system may include a user interface.

According to some embodiments of the present invention, there is provided a computer-implemented method for detecting a characteristic in samples of a set of samples. The method may include applying, in a training stage, a first detection algorithm and a second detection algorithm on a training subset of the set of samples and obtaining a first set and a second set of detection results indicating samples of the set of samples in which the characteristic was detected, the second detection algorithm being more sensitive than the first detection algorithm, and presenting to the user, using a user interface, a list of results which are obtained by subtracting the first set of results from the second set of results, as misdetection candidates, for the user to consider if to indicate as including the characteristic.

In some embodiments, the method may include obtaining from the user an indication for a misdetection candidate of the misdetection candidates includes the characteristic.

In some embodiments, the method may include presenting the first set of results to the user as false alarm candidates.

According to some embodiments, the method may include obtaining from the user indication for a false alarm candidate of the false alarm candidates does not include the characteristic.

In accordance with some embodiments of the present invention, there is provided a system for detecting a characteristic in samples of a set of samples, with a processing unit configured to apply, in a training stage, a first detection algorithm and a second detection algorithm on a training subset of the set of samples and obtaining a first set and a second set of detection results indicating samples of the set of samples in which the characteristic was detected, the second detection algorithm being more sensitive than the first detection algorithm, and present to the user, using a user interface, a list of results which are obtained by subtracting the first set of results from the second set of results, as misdetection candidates, for the user to consider if to indicate as including the characteristic.

### BRIEF DESCRIPTION OF THE DRAWINGS

In order to better illustrate examples, the following figures are provided and referenced hereafter. It should be noted that the figures are given as examples only and in no way limit the scope of the present disclosure. It will be appreciated that for simplicity and clarity of illustration, elements shown in the figures have not necessarily been drawn to scale. For example, the dimensions of some of the elements may be exaggerated relative to other elements for clarity. Like components are denoted by like reference numerals.

FIG. 1A illustrates an image that includes a portion of an object to be detected, as an example of a false-alarm.

FIG. 1B illustrates another example of an image with a portion of the object to be detected, as an example of a false-alarm.

FIG. 2A illustrates division of a set of image samples into two subsets—training and subset test subset, according to some embodiments of the present invention.

FIG. 2B illustrates an image with several areas in which the object to be detected is located wherein the remaining area of the image is clear of that object.

FIG. 3 illustrates a process for obtaining an optimized detection algorithm according to embodiments of the present invention.

FIG. 4 illustrates a method of identifying misdetection candidates in a detection system, according to embodiments of the present invention.

FIG. 5 illustrates a method of identifying false-positive (false-alarm) candidates in a detection system, according to embodiments of the present invention.

FIG. 6 illustrates a method for detecting a characteristic in samples of a set of samples, according to embodiments of the present invention.

FIG. 7 illustrates a system for detecting a characteristic in samples of a sample set according to some embodiments of the invention.

### DETAILED DESCRIPTION OF THE INVENTION

In the following detailed description, numerous specific details are set forth in order to provide a thorough understanding of the methods and systems. However, it will be understood by those skilled in the art that the present methods and systems may be practiced without these specific details. In other instances, well-known methods, procedures, and components have not been described in detail so as not to obscure the present methods and systems.

Although the examples disclosed and discussed herein are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method examples described herein are not constrained to a particular order or sequence. Additionally, some of the described method examples or elements thereof can occur or be performed at the same point in time.

Unless specifically stated otherwise, as apparent from the following discussions, it is appreciated that throughout the specification, discussions utilizing terms such as “adding”, “associating” “selecting,” “evaluating,” “processing,” “computing,” “calculating,” “determining,” “designating,” “allocating” or the like, refer to the actions and/or processes of a computer, computer processor or computing system, or similar electronic computing device, that manipulate, execute and/or transform data represented as physical, such as electronic, quantities within the computing system's registers and/or memories into other data similarly represented as physical quantities within the computing system's memories, registers or other such information storage, transmission or display devices.

While some embodiments of the present invention are described hereinafter with reference video imaging examples, it should be noted that some embodiments of the present invention are not limited to video detectors and may relate to other kinds of sensors, detectors etc.

Various different kinds of events may be associated with detection problems, some of which may include change of an outlined event (an object entering or leaving a region of interest—ROI), change of direction of an outlined event (e.g., a car driven on a highway in the opposite direction of the traffic flow, etc.) a suspicious color event (e.g., a red car entering the ROI), object tracking, face detection/recognition, pedestrian detection, sound detection (e.g., detecting specific noise or sound)

It would be appreciated that the above problems are not unique to the surveillance world, and can be demonstrated in other fields. For instance, the problem of detecting a misplaced object in an ROI is similar to detecting tumors in a medical imaging system or spotting patterns in heart waveform measurements.

To date, the performance of general purpose detectors is typically fairly inadequate due to the trade-off between misdetection and false alarm rate. A practical required level of misdetection leads to a high level of false alarm rate which is particularly detrimental when a large system is controlling a multiplicity of detectors. The false alarm rate of the entire system is typically determined by multiplying the false alarm rate of a single detecting device by the number of detecting devices in the system. For instance, even when the false alarm rate of a detecting device is one per day with a single sensor, the false alarm rate of a system including 1000 sensors is 1000 per day, a rate which is too high to be acceptable. The use of multiple sensors for a given detector system is a measure that can be taken to improve detector performance since each sensor feature, if suitably selected, can add orthogonally to the level of detection. Combined detected features from non-related sensors can improve the quality of detection and thus reduce false alarm rate.

Embodiments of the present invention are hereinafter described with respect to object detection in acquired images. However, the present invention is not limited to object detection in images and may apply to the detection of any event or characteristic in sensed samples from a set of sample acquired by a detection system that includes one or a plurality of sensors. An “event” may refer to an object in an image, a specific sound or noise in an audio sample, a specific measurement reading in a succession of measurement readings (e.g., specific temperature range within a succession of temperature readings), etc.

“Image” or “images”, in the context of the present specification relates to still or video image or images.

Object detection is a technology aimed at detecting and localizing specific objects in a set of acquired images. Examples of object detection applications could be face detection, pedestrian detection, cars detection etc. Object detection techniques could be carried our using a human-supervised (hereinafter “supervised”) learning machine and using computer vision methods. In a classic supervised learning scheme, a human supervisor identifies and indicates images of the set of acquired images as “object” or “non-object” examples for the learning machine (“Training phase”), to create a specific object detection algorithm (classifier/model).

In supervised learning, each example is represented by a pair consisting of an input vector representing the object, and a desired output value (e.g., given by the supervisor). In supervised learning, the detection algorithm is used to analyze the training data with a set of detection criteria, and in the learning process, the detection algorithm is modified by modifying the set of detection criteria (sometimes referred to as “classifier”). The classifier is designed to predict the correct output value for any valid input object. This requires the detection algorithm process to generalize from the training data to be capable of detecting the object to be detected in samples that have not been previously presented to the detection system.

The process of establishing valid object detection (based on learning machine) typically includes several main tasks: data collection, Algorithmic design and Performance evaluation.

Typically, in data collection, the supervisor decides which examples will be added to the learning machine and how many. This is often difficult to decide. For example, for training a pedestrian detector in an outdoor surveillance camera, one may need to collect thousands of training examples (pedestrian and non-pedestrian examples).

A typical training phase of a supervised detection algorithm process may include several rounds of examples feeding to the system. Each round may includes adding Positive (“object”) and Negative (“non-object”) examples. Usually, examples given to the system at that stage are based on misdetections (“positive” examples), and “false alarms” (“negative” examples) in the previous round.

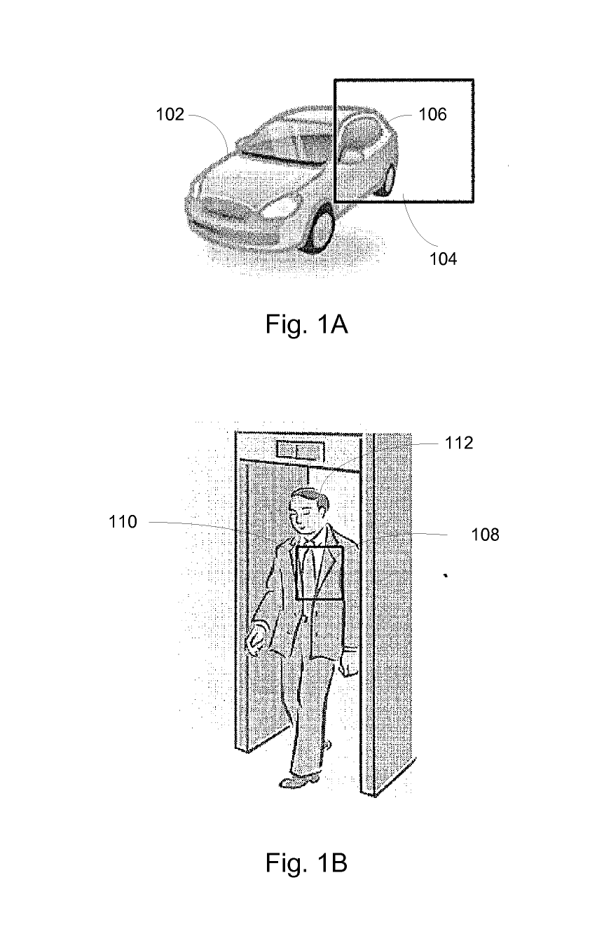

Collecting negative examples manually is a time consuming operation. To ease the process, usually, relevant false alarms are collected by creating a data set that includes only images that do not contain object examples. Then, running the algorithm with these examples by adding the examples to the negative data set. Still, it is difficult to automatically collect with this method marginal false-alarms. For example, in a car detection application, many false alarms may appear on sub-regions of the object (See, for example, FIG. 1A, where only a portion 106 of car 102 appears in image frame 104). Another example is shown in FIG. 1B, that relates to face detection application where a typical false-alarm may be detected on a “non-face” body region 108 of a person 112 that is caught in an image 110. Without adding these examples, the algorithm performance may be badly affected (and thus badly affecting the application that is based on it).

When designing the algorithm, the developer typically tries to obtain the best performance by different feature (descriptors) extraction methods, by using different learning machine methods or even by just using specific parameter calibration. The challenge for the developer is to find the best combination of examples and parameters calibration.

In order to determine the best combination of example feeding/changing for the algorithmic design, each training round may be typically followed by a performance evaluation step.

“Performance” in the context of the present specification may relate to any parameter or parameters which the designer of the learning process may find to be desired. For example, performance may relate to a certainty level of the outcome of the detection process (e.g., the quality of detection). In another example, performance may relate to the processing time that the detection algorithm (generated in the learning process) would need to perform detection, e.g., shorter processing times may be more desired, possibly generating a detection algorithm that is capable of producing detection results in real-time or near real-time. “Performance” may also relate to combinations of these parameters, and/or any other performance parameters. In some embodiments, various weights would be assigned to performance parameters in the determination of a level of detection performance.

In another example, a common representation of the performance of an object detection algorithm may be illustrated using a Receiver Operating Characteristic (ROC) curve. A ROC curve may be created by plotting the detection rate vs. the false positives rate at various threshold settings of the algorithm. The developer/user usually does not have a direct indication whether the performance was really improved without comparing the ROC curves. Many times, developers/users test a new algorithm with respect to a specific threshold only, because it may take very long time to produce a reliable ROC curve. Thus, the decision when to stop the training and development process is in many instances not clear enough. The quality of the model depends heavily on these tasks. Thus, a full process of training and developing an object detection algorithm in some difficult scenarios, (relevant data collection, feeding back the system, algorithmic issues and performance evaluation) could take even few weeks and could be very tedious.

The samples, in the context of the present specification, may be, for example, still images or video stream or streams, audio samples, pressure, temperature, or other measurement readings, or any other samples of data. These samples may be acquired by one or a plurality of sensors, and collected for processing as a set of samples.

For the sake of brevity, object detection in images of an image set is discussed herein.

A “characteristic”, in the context of the present specification, may refer to any feature of the sample which is to be detected. For sake of brevity, in the discussion hereinafter the characteristic is an object which needs to be detected in images of an image set.

According to some embodiments of the present invention, the user may provide the object detection system with examples of the object to be detected.

In some embodiments of the present invention, the user would provide these examples by indicating those images of the image set of examples where the object to be detected is found.

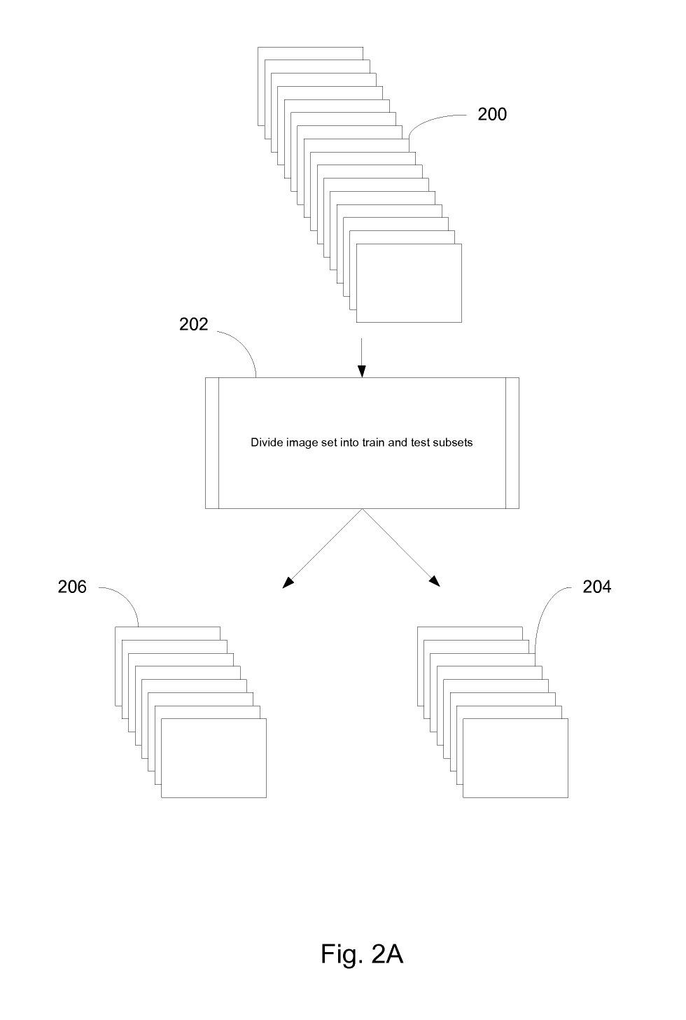

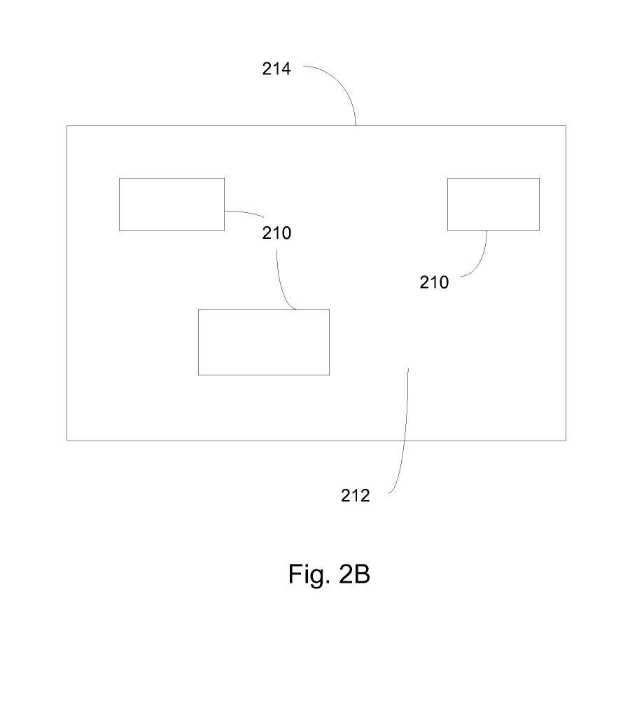

According to some embodiments of the present invention, the detection system divides the set of image samples, e.g., n samples, 200 (see FIG. 2A) into two subsets 204, 206, each of the samples of the set of samples being assigned to only one of the subsets. According to some embodiments, the division may be carried out randomly. In other embodiments of the invention, that division may be carried out otherwise. As a result, each sample would be included in just one of the subsets. One of the subsets 204 may be considered as a training subset and the other set may be considered as a validation subset 206 (also referred to as—“test subset”).

The detection system may then iteratively classify samples from the set of image samples as “object” or “non-object” examples using one or a plurality detection criteria of for training the system.

The detection criteria, according to some embodiments, may be selected in a random manner. In the context of the present specification “random” may, in addition to the its normal usage, also refer to a selection by a processor, where the processor performs such selection without an input from a user, and without reference to a pre-determined suitability of such selection for a particular purpose or goal.

By relating to the examples provided by the user, the system may automatically classify as “object” examples images that were indicated by the user as “object” examples but not detected by the system (due to misdetection), or automatically add to the “non-object” examples images that were indicated by the user as non-object images, despite being determined by the detection system as containing the object (false-positive). In some embodiments of the present invention, in images (e.g., image 214 in FIG. 2B) where the user has indicated areas 210 as including the object to be detected, the remaining area or areas 212 of these images would be considered by the detection system to be free of the object (e.g., “non-object area”).

The detection system starts by taking a sub-group of the collected object examples and a sub-group of the non-object examples (from regions that the user did not mark as including the object to be detected) to create, in a supervised learning process, a detection algorithm for detecting the object where it appears in the samples (in other words—classifying the images). Then, the system runs several learning processes iterations of classification of the images on the training subset (automatically adding in these iterations object and non-object and negatives examples).

After each learning iteration, the system may evaluate its performance, for example, by computing the ROC curve: true-positives rate (e.g., percentage of true detection) vs. false-positive rate curve. The true-positive rate may be computed, for example, using the object examples provided by the user.

False-positive rate may be calculated based on the assumption that if the user did not mark a specific region as “object” and the system nevertheless has detected an “object” in that region—that would constitute a false-positive detection. In taking this assumption the system is able to treat images or areas of the images which were not marked by the user as containing the object to be detected as non-object areas in a high level of confidence, adding to the reliability of the entire learning process. Relating to this assumption simplifies collection of negative examples relieving the human user from this task or greatly reducing the user's involvement in the process.

The system would continue the iterative learning process until a desired performance level, e.g., a desired ROC curve is reached (e.g., a threshold). During these iterations, the system may change the selection of the detection criteria to enhance the performance of the learning process, amending the classification algorithm or the detection criteria used to find the characteristic in the samples until an optimized or acceptable classification algorithm is obtained.

Upon reaching the desired ROC curve, the system would run the classification algorithm on the test set to verify the validity of the optimized classification algorithm that was reached. The validation process may be executed, in some embodiments of the present invention with different feature extraction methods, with a different detection algorithm methodology (e.g., Neural networks, Support Vector Machine, combination of several algorithms etc.), with different feature extraction methods (e.g., Scale Invariant Feature Transform—SIFT, Hystogram of Oriented Gradient—HOG, combination of several methods, etc.) and with different parameters calibration.

According to embodiments of the present invention, an optimized or preferred detection algorithm may be reached. Another benefit of the automated process according to some embodiments of the present invention is the availability of a performance ROC prediction for the optimized detection algorithm with real-time prediction of processing time to reach the desired ROC. Furthermore, methods and systems according to some embodiments of the present invention may outperform other known methods and systems due to the large amount (automatically generated) of components permutations which are involved in the system training and design. Performing this process manually is almost infeasible.

According to some embodiments, the user may be presented, via a user interface, samples of the set of samples that were not indicated by the user as including the characteristic, for the user to verify whether the characteristic is or is not included in these samples.

In some embodiments, the samples presented to the user may be samples that were not indicated by the user as including the object but were detected by the modified detection algorithm as including the object with a certainty level of or above a predetermined value.

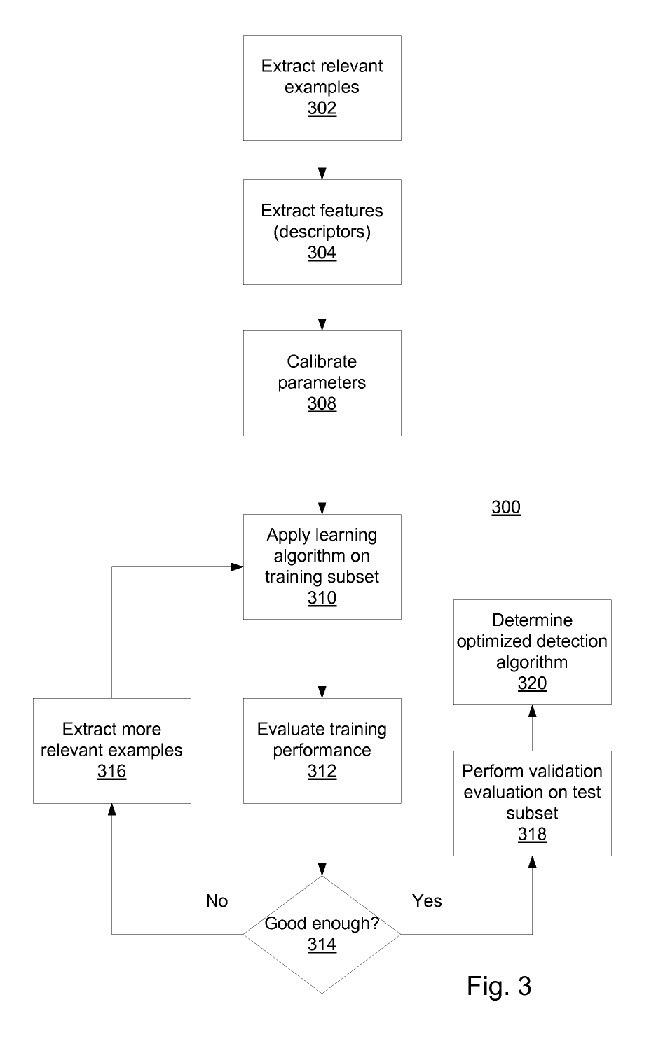

In some embodiments, the samples presented to the user may be samples that were not indicated by the user as including the characteristic but were found by the modified detection algorithm to include the characteristic within a predetermined range of certainty levels. FIG. 3 illustrates a process 300 for obtaining an optimized detection algorithm according to some embodiments of the present invention.

After a user provides object and non-object examples from a set of images in which an object is to be detected or looked for, relevant examples 302 from a training subset of the set of images, and features 304 are extracted and classification parameters calibrated 308. A detection algorithm may be applied to the training subset 310, where the detection algorithm includes detection criteria that may be used to detect the characteristic in a sample, and the performance of the training or detection algorithm evaluated 312. It is then determined whether the performance is good enough 314 in detecting as positive those examples that were indicated by the user as including the characteristic, and in detecting as negative those samples that the were indicated by the user as not including the characteristic. If it is not (e.g., the ROC curve is not satisfactory), more relevant examples are extracted 316 from the training subset, and the detection algorithm is iteratively applied 310, until the desired performance is reached (e.g., the desired ROC curve is obtained). At that point, validation evaluation or testing of the obtained detection algorithm is performed 318 on a second set of samples that a user had also reviewed and marked as either including or not including the characteristic, and the detection algorithm may be tested for accuracy using such second set of samples.

The quality of the obtained optimized detection algorithm may depend on the examples provided by the user in the training stage. Once an optimized model is created, it is used to detect and recognize the specific object in the image. In human-supervised learning, each example is a pair consisting of an input vector representing the object and a desired output value. A human-supervised detection algorithm analyzes the training or learning data and produces an optimized algorithm (also referred to sometimes as a classifier or criteria). The classifier is designed to predict the correct output value for any valid input object. This requires the detection algorithm to generalize from the training data to new data that has not been previously processed. In the training stage in an object detection system, a known problem relates to the data collection stage and how to collect relevant examples. For example, for training a pedestrian detector in an outdoor surveillance camera, one should collect thousands of training examples (pedestrian and non-pedestrian examples). In a non-busy scene, one has to watch the video for several days to be able to find relevant examples of the object. Especially, it is very hard to find and collect misdetection examples in such scenarios. The algorithm decision making typically depends on a function in which the final result depends on a threshold (e.g., if the function result is above a predefined threshold, decide: “Object”, otherwise, decide: “Non-Object”). The threshold value defines the misdetection vs. false alarms rate. A higher value of the threshold leads to more “misdetection” and less “false-alarms” and vice versa.

According to some embodiments of the present invention, the training stage may be accelerated thereby enhancing classification accuracy of the automated detection system by automatically offering to the user, good image examples to select and provide for the training stage of the detection system. According to some embodiments of the present invention, the classifier results are filtered or sorted such that the most relevant examples for the training stage may be suggested automatically by the detection system (acting as the examples collector) to the user in a simple manner.

The examples for training the detection system may be divided into two groups: “object” example and “non-object” examples. “Object” examples may be provided by the user to the automated detection system when the system does not automatically detect them (misdetection), and “non-object” examples may be provided by the user to the automated detection system in false alarm scenarios (when “non-object” images are classified by the detection system as including the object to be detected).

According to some embodiments of the present invention, a solution for finding the potential misdetections is introduced, by running an object detection algorithm (algorithm A) in conjunction with another, more sensitive object detection algorithm (lower value of threshold) (algorithm B)

The algorithms can be any suitable algorithm such as, for example, Viola & Jones algorithm as described in P. Viola, M. Jones, “Robust Real-Time object detection”, Second International workshop on statistical and computational theories of Vision, 2001 (as algorithm A), and a similar algorithm with a lower value of threshold in the last cascade (as algorithm B). Other algorithms may also be used.

It would normally be expected that Algorithm B would have yield more detections than algorithm A due to its lower threshold.

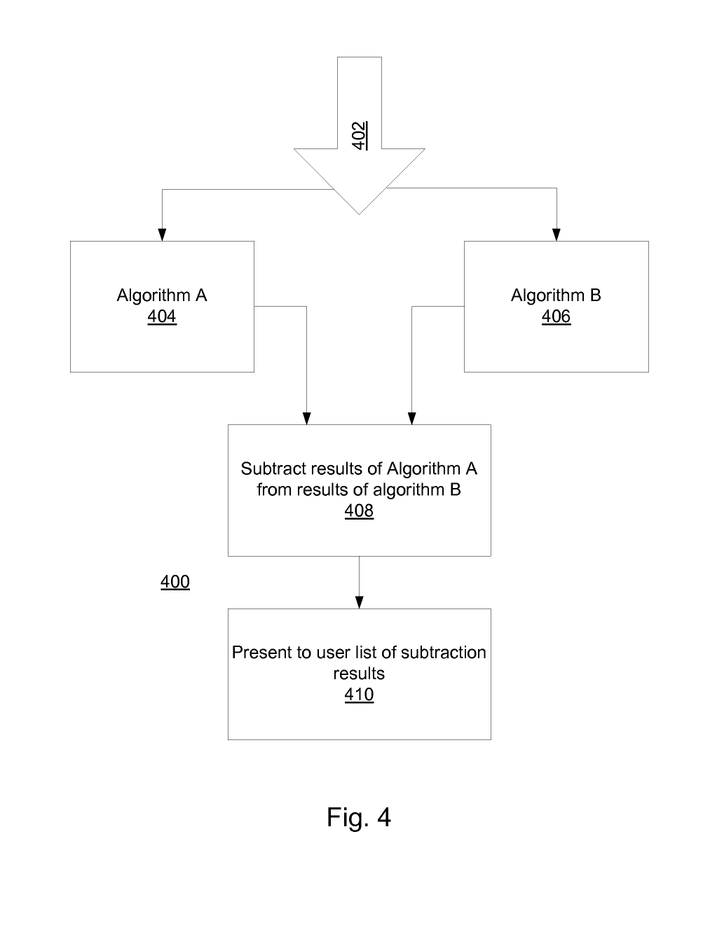

FIG. 4 illustrates a method of identifying misdetection candidates in a detection system, according to some embodiments of the present invention. In some embodiments, a user interface is provided which presents the user with a list of results that were the output as positive detections from an application of algorithm B, and were not detected by algorithm A. This may be obtained by applying algorithm A 404 and algorithm B 406 in the image set 402, subtracting 408 the results obtained by algorithm A from the results obtained by algorithm B and presenting 410 the list of subtracted results to the user, e.g., using a user interface. The presented list includes the result of subtracting from the results of algorithm B all of the results of algorithm A). In this way, a list of image blocks that did not pass the original algorithm threshold of algorithm A, but were fairly close to being detected (and in fact were detected by algorithm B). Usually, misdetections are a sub-group of such a list. This list is in fact a list of misdetection candidates that is provided to the user in order to help the user find quickly misdetection instances. The user may verify that indeed a misdetection had occurred and in that case indicate the image as an “object” example, and provide this information to the detection system (e.g. in the learning stage). Alternatively, a user may confirm the detection resulting from algorithm B as a positive example, and instruct a system to optimize algorithm A so that it detects the detection that had theretofore been missed by algorithm A.

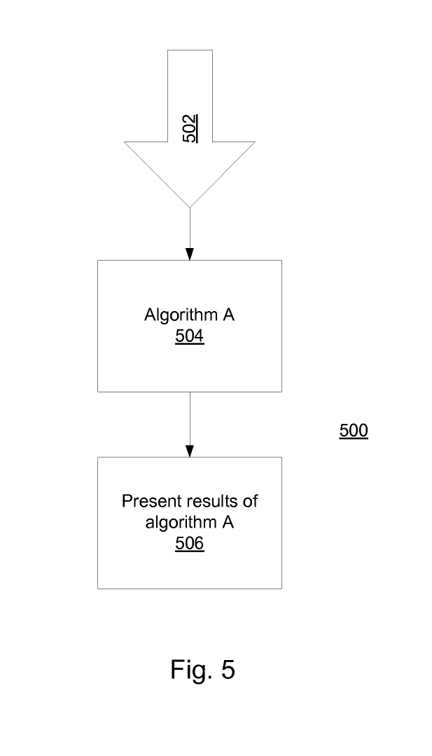

FIG. 5 illustrates a method of identifying false-positive (false-alarm) candidates in a detection system, according to some embodiments of the present invention. The method 500 may include applying 504 object detection algorithm (algorithm A) on the image set 502 and presenting 506 the user with a list of results. The false-alarms are a sub-group of this list, thus all results of this list are candidates false-alarms.

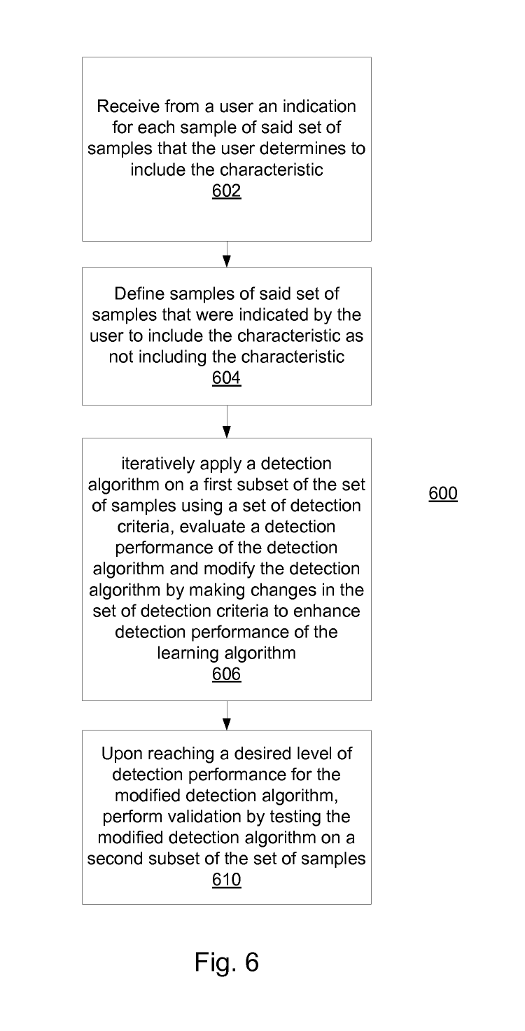

FIG. 6 illustrates a method for detecting a characteristic in samples of a set of samples, according to embodiments of the present invention. A computer-implemented method 600 may include receiving 602 from a user an indication for each sample of said set of samples that the user determines to include the characteristic. The method 600 may also include defining 604 samples of said set of samples that were indicated by the user to include the characteristic as not including the characteristic. The method may further include iteratively applying 606 by a processing unit, a detection algorithm on a first subset of the set of samples, said detection algorithm using a set of detection criteria that includes one or a plurality of detection criteria, evaluating a detection performance of the detection algorithm and modifying the detection algorithm by making changes in the set of detection criteria to enhance detection performance of the learning algorithm. The method 600 may still further include, upon reaching a desired level of detection performance for the modified detection algorithm, performing 610 validation by testing the modified detection algorithm on a second subset of the set of samples.

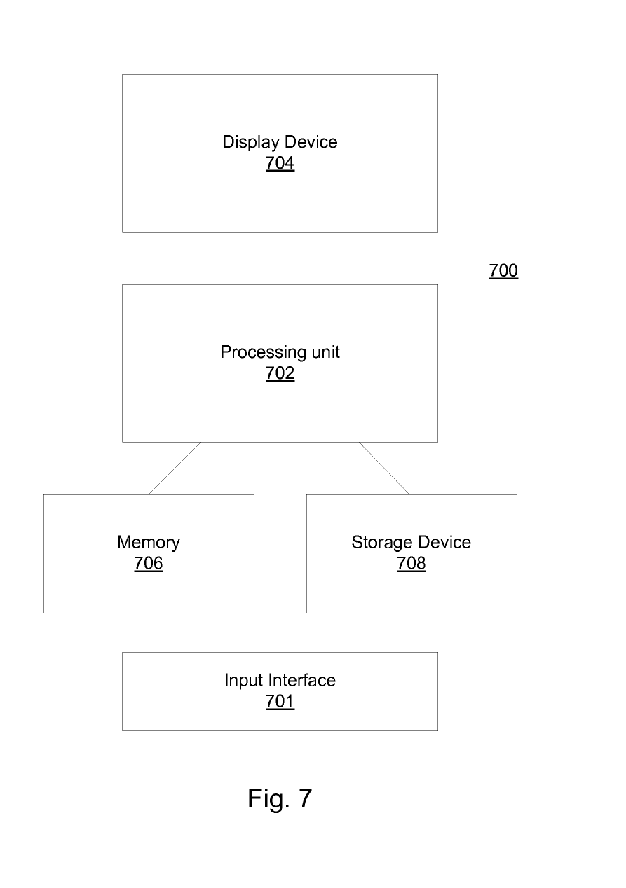

FIG. 7 illustrates a system 700 for detecting a characteristic in a sample set according to some embodiments of the invention.

System 700 may include a processing unit 702 (e.g., one or a plurality of processors, on a single machine or distributed on a plurality of machines) for executing a method according to some embodiments. Processing unit 702 may be linked with memory 706 on which a program implementing a method according to examples and corresponding data may be loaded and run from, and storage device 708, which includes a non-transitory computer readable medium (or mediums) such as, for example, one or a plurality of hard disks, flash memory devices, etc. on which a program implementing a method according to examples and corresponding data may be stored. System 700 may further include display device 704 (e.g., CRT, LCD, LED, etc.) on which one or a plurality of user interfaces associated with a program implementing a method according to some embodiments of the present invention and corresponding data may be presented. System 700 may also include input device 701, such as, for example, one or a plurality of keyboards, pointing devices, touch sensitive surfaces (e.g., touch sensitive screens), etc., for allowing a user to input commands and data.

Some embodiments of the present invention may be embodied in the form of a system, a method or a computer program product. Similarly, examples may be embodied as hardware, software or a combination of both. Some embodiments of the present invention may be embodied as a computer program product saved on one or more non-transitory computer readable medium (or media) in the form of computer readable program code embodied thereon. Such non-transitory computer readable medium may include instructions that when executed cause a processor to execute method steps in accordance with some embodiments. In some embodiments, the instructions stored on the computer readable medium may be in the form of an installed application and in the form of an installation package.

Such instructions may be, for example, loaded by one or more processors and get executed.

For example, the computer readable medium may be a non-transitory computer readable storage medium. A non-transitory computer readable storage medium may be, for example, an electronic, optical, magnetic, electromagnetic, infrared, or semiconductor system, apparatus, or device, or any combination thereof.

Computer program code may be written in any suitable programming language. The program code may execute on a single computer system, or on a plurality of computer systems.

Embodiments of the present invention are described hereinabove with reference to flowcharts and/or block diagrams depicting methods, systems and computer program products according to various embodiments.

Features of various embodiments discussed herein may be used with other embodiments discussed herein. The foregoing description of the embodiments has been presented for the purposes of illustration and description. It is not intended to be exhaustive or limiting to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes that fall within the true spirit of the disclosure.

1. A computer-implemented method for detecting a characteristic in a sample of a set of samples, the method comprising:
receiving from a user an indication for each sample of said set of samples that the user determines to include the characteristic;
defining samples of said set of samples that were not indicated by the user to include the characteristic as not including the characteristic;
iteratively, applying by a processing unit, a detection algorithm on a first subset of the set of samples, said detection algorithm using a set of detection criteria that includes one or a plurality of detection criteria, evaluating a detection performance of the detection algorithm and modifying the detection algorithm by making changes in the set of detection criteria to enhance detection performance of the learning algorithm;
upon reaching a desired level of detection performance for the modified detection algorithm, performing validation by testing the modified detection algorithm on a second subset of the set of samples.

2. The method of claim 1, further comprising presenting to the user, via a user interface, samples of the set of samples that were not indicated by the user as including the characteristic, for the user to verify whether the characteristic is or is not included in these samples.

3. The method of claim 2, wherein the samples of the set of samples that were not indicated by the user as including the characteristic where found by the modified detection algorithm to include the characteristic with a certainty level of or above a predetermined value.

4. The method of claim 2, wherein the samples of the set of samples that were not indicated by the user as including the characteristic where found by the modified detection algorithm to include the characteristic within a predetermined range of certainty levels.

5. The method of claim 1, wherein the samples comprise images and wherein the characteristic comprises an object to be detected in the images.

6. The method of claim 1, wherein the detection criteria are selected randomly.

7. A system for detecting a characteristic in a sample of a set of samples, the system comprising a processing unit configured to:
receive from a user an indication for each sample of said set of samples that the user determines to include the characteristic;
define samples of said set of samples that were not indicated by the user to include the characteristic as not including the characteristic;
iteratively, apply by a processing unit, a detection algorithm on a first subset of the set of samples, said detection algorithm using a set of detection criteria that includes one or a plurality of detection criteria, evaluate a detection performance of the detection algorithm and modify the detection algorithm by making changes in the set of detection criteria to enhance detection performance of the learning algorithm;
upon reaching a desired level of detection performance for the modified detection algorithm, perform validation by testing the modified detection algorithm on a second subset of the set of samples.

8. The system of claim 7, wherein the processing unit is further configured to present to the user, via a user interface, samples of the set of samples that were not indicated by the user as including the characteristic, for the user to verify whether the characteristic is or is not included in these samples.

9. The system of claim 8, wherein the samples of the set of samples that were not indicated by the user as including the characteristic were found by the modified detection algorithm to include the characteristic with a certainty level of or above a predetermined value.

10. The system of claim 8, wherein the samples of the set of samples that were not indicated by the user as including the characteristic were found by the modified detection algorithm to include the characteristic within a predetermined range of certainty levels.

11. The system of claim 7, wherein the samples comprise images and wherein the characteristic comprises an object to be detected in the images.

12. The system of claim 7, further comprising a user interface.

13. The system of claim 1, wherein the processing unit is configured to select the detection criteria randomly.

14. A computer-implemented method for detecting a characteristic in samples of a set of samples, the method comprising:
applying, in a training stage, a first detection algorithm and a second detection algorithm on a training subset of the set of samples and obtaining a first set and a second set of detection results indicating samples of the set of samples in which the characteristic was detected, the second detection algorithm being more sensitive than the first detection algorithm, and presenting to the user, using a user interface, a list of results which are obtained by subtracting the first set of results from the second set of results, as misdetection candidates, for the user to consider if to indicate as including the characteristic.

15. The method of claim 14, further comprising obtaining from the user an indication for a misdetection candidate of the misdetection candidates includes the characteristic.

16. The method of claim 15, further comprising presenting the first set of results to the user as false alarm candidates.

17. The method of claim 16, further comprising obtaining from the user an indication for a false alarm candidate of the false alarm candidates does not include the characteristic.

18. A system for detecting a characteristic in samples of a set of samples, the system comprising a processing unit configured to:
apply, in a training stage, a first detection algorithm and a second detection algorithm on a training subset of the set of samples and obtaining a first set and a second set of detection results indicating samples of the set of samples in which the characteristic was detected, the second detection algorithm being more sensitive than the first detection algorithm, and present to the user, using a user interface, a list of results which are obtained by subtracting the first set of results from the second set of results, as misdetection candidates, for the user to consider if to indicate as including the characteristic.

19. The system of claim 18, wherein the processing unit is further configured to obtain from the user an indication for a misdetection candidate of the misdetection candidates includes the characteristic.

20. The system of claim 18, wherein the processing unit is further configured to present the first set of results to the user as false alarm candidates.

21. The system of claim 20, wherein the processing unit is further configured to obtain from the user an indication for a false alarm candidate of the false alarm candidates does not include the characteristic.
